(19) United States
(12) Patent Application Publication
(10) Pub. No.: US 2013/0330140 A1
(43) Pub. Date: Dec. 12, 2013

(54) REVERSIBLE TOOL ASSEMBLY

(71) Applicant: Hsuan-Sen SHIAO, Taichung City (TW)

(72) Inventor: Hsuan-Sen SHIAO, Taichung City (TW)

(21) Appl. No.: 13/493,889

(22) Filed: Jun. 11, 2012

(51) Int. Cl. B25F 3/00

(52) U.S. Cl. 408/226

(57) ABSTRACT

A reversible tool assembly includes a main member, a driven unit for driving the main member to rotate about an axis, first and second movable members coupled respectively to the main member and movable in the direction of the axis, and a reversible tool unit mounted pivotally between the first and second movable members. The reversible tool unit is movable together with the first and second movable members between an extended position, where pivot action thereof is permitted, and a retracted position, where pivot action thereof is not permitted.

### BACKGROUND OF THE INVENTION

1. Field of the Invention

The invention relates to a tool assembly, more particularly to a reversible tool assembly.

2. Description of the Related Art

A conventional reversible drill and drive tool assembly, such as ones illustrated in U.S. Pat. Nos. 7,237,987B2, 6,877,937B2 and 4,512,693, generally includes a main member having one end that is connected co-rotatably to a driven shaft driven rotatably by a pneumatic driving device, and a two-ended reversible tool unit connected movably to an opposite end of the main member. The conventional reversible drill and drive tool assembly further includes a driving member for driving movement of the reversible tool unit relative to the main member between a pivotable position and a non-pivotable position, and a biasing member for biasing the reversible tool unit toward the non-pivotable position.

In U.S. Pat. No. 4,676,703, there is disclosed another conventional reversible drill and drive tool assembly that includes a main holding member having one end connected to a driven rod that is driven rotatably by a pneumatic driving device, and an opposite end having a pivot axle to which a reversible tool unit is pivotally connected. The conventional reversible drill and drive tool assembly disclosed in U.S. Pat. No. 4,676,703 further includes a pair of positioning assemblies, each of which has a pair of positioning holes formed in the reversible tool unit, and a fastener engaging a respective one of the positioning holes for positioning the reversible tool unit relative to the main holding member. However, the conventional reversible drill and drive tool assembly disclosed in U.S. Pat. No. 4,676,703 has several disadvantages, such as weak overall structural strength, which may render the pivot axle less durable and may thus lead to a relatively poor torsion transmission efficiency, and a complicated positioning procedure for positioning the reversible tool unit relative to the main holding member.

### SUMMARY OF THE INVENTION

Therefore, an object of the present invention is to provide a reversible tool assembly that has a relatively high structural strength, and that is capable of outputting a high rotational torque.

Accordingly, a reversible tool assembly of this invention comprises a main member, a driven unit, first and second movable members, an operating unit, a limiting unit and a reversible tool unit. The main member surrounds an axis, and has first and second side walls that are disposed at opposite sides of and that extend parallel to the axis, and a pair of interconnecting walls that interconnect the first and second side walls. The first and second side walls are formed respectively with first and second engaging grooves that extend in the direction of the axis. The driven unit includes a driven shaft that is rotatable on the axis, and a coupling seat that is driven rotatably by the driven shaft and that is coupled to the main member such that the main member is co-rotatable with the coupling seat. Each of the first and second movable members has an engaging end portion that engages slidably a respective one of the first and second engaging grooves, and a pivot end portion that is opposite to the engaging end portion in the direction of the axis. The operating unit includes a sleeve member that surrounds the main member and that is coupled co-movably to the first and second movable members. The limiting unit is provided on the main member and the sleeve member of the operating unit for limiting movement of the first and second movable members together with the sleeve member along the first and second engaging grooves. The reversible tool unit includes a base block that is disposed between the pivot end portions of the first and second movable members, a pivot pin that extends in a direction transverse to the axis and that connects pivotally the base block to the pivot end portions of the first and second movable members, and first and second tool heads that extend respectively from axially-opposite sides of the base block in opposite directions along the axis. The reversible tool unit is movable through the movement of the first and second movable members between an extended position, where the first and second tool heads are separated from the main member and pivot action of the base block together with the first and second tool heads on the pivot pin is permitted, and a retracted position, where one of the first and second tool heads is retained in the main member and pivot action of the base block together with the first and second tool heads on the pivot pin is not permitted.

### BRIEF DESCRIPTION OF THE DRAWINGS

Other features and advantages of the present invention will become apparent in the following detailed description of the preferred embodiment with reference to the accompanying drawings, of which:

FIG. 1 is an assembled perspective view of the preferred embodiment of a reversible tool assembly according to the present invention;

FIG. 2 is an exploded perspective view of the preferred embodiment;

FIG. 3 is another exploded perspective view of the preferred embodiment;

FIG. 4 is a sectional view of the preferred embodiment taken along line IV-IV in FIG. 1, illustrating a reversible tool unit at a retracted position, and a surrounding locking member of a locking unit is at a locked position;

FIG. 5 is a sectional view of the preferred embodiment taken along line V-V in FIG. 4;

FIG. 6 is a sectional view of the preferred embodiment taken along line VI-VI in FIG. 4;

FIG. 7 is a view similar to FIG. 4, but illustrating the surrounding locking member at an unlocked position;

FIG. 8 is a fragmentary sectional view of the preferred embodiment, illustrating the reversible tool unit at an extended position;

FIG. 9 is another fragmentary sectional view of the preferred embodiment, illustrating the reversible tool unit being rotated for 180 degrees; and

FIG. 10 is another sectional view of the preferred embodiment illustrating the reversible tool unit at the retracted position and the surrounding locking member at the unlocked position.

### DETAILED DESCRIPTION OF THE PREFERRED EMBODIMENT

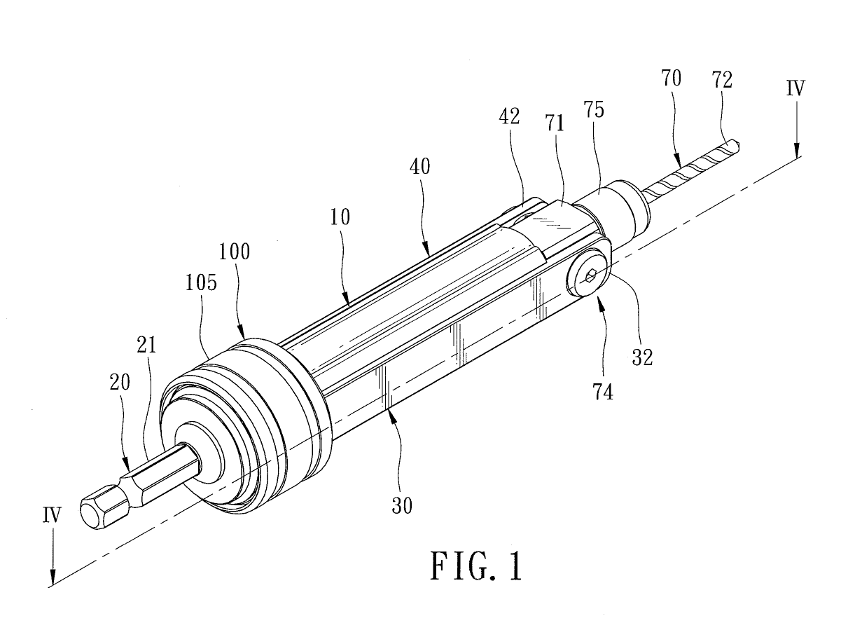

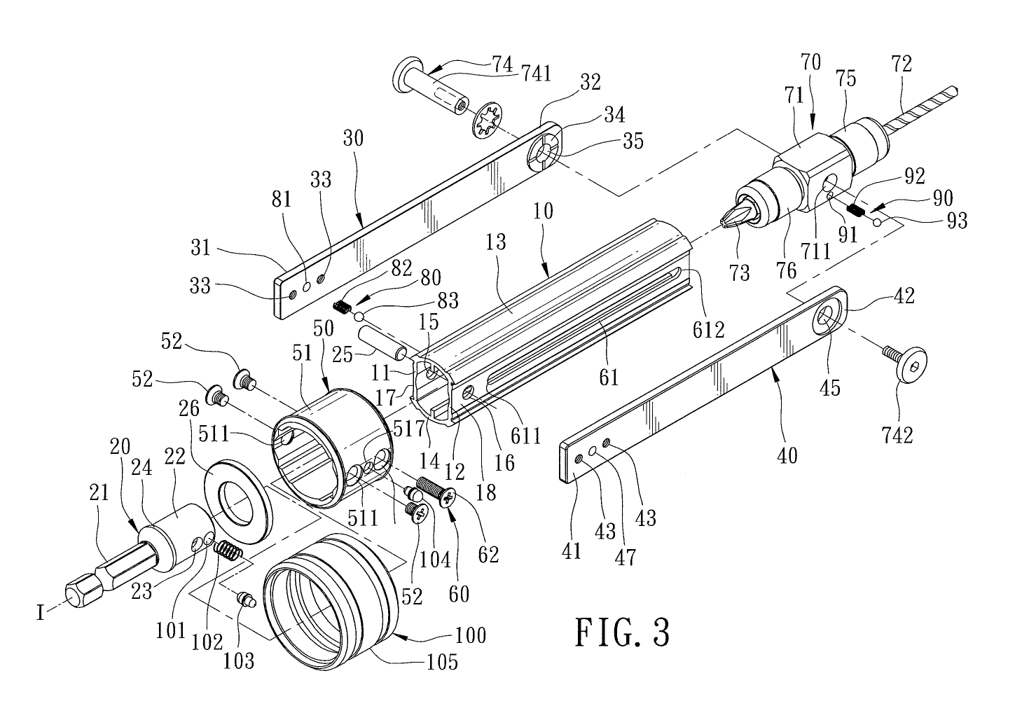

As shown in FIGS. 1 to 6, the preferred embodiment of a reversible tool assembly according to the present invention is shown to comprise a main member 10, a driven unit 20, a first movable member 30, a second movable member 40, an operating unit 50, a limiting unit 60, a reversible tool unit 70, a positioning unit 80, an angular positioning unit 90 and a locking unit 100.

The main member 10 is disposed to surround an axis (I), and has first and second side walls 11, 12 that are disposed on opposite sides of the axis (I) and that extend parallel to the axis (I), and a pair of interconnecting walls 13, 14 that interconnect the first and second side walls 11, 12. The first and second side walls 11, 12 are formed respectively with first and second through holes 15, 16 that extends in a direction perpendicular to the axis (I), and are further formed respectively with first and second engaging grooves 17, 18 that extend parallel to the axis (I).

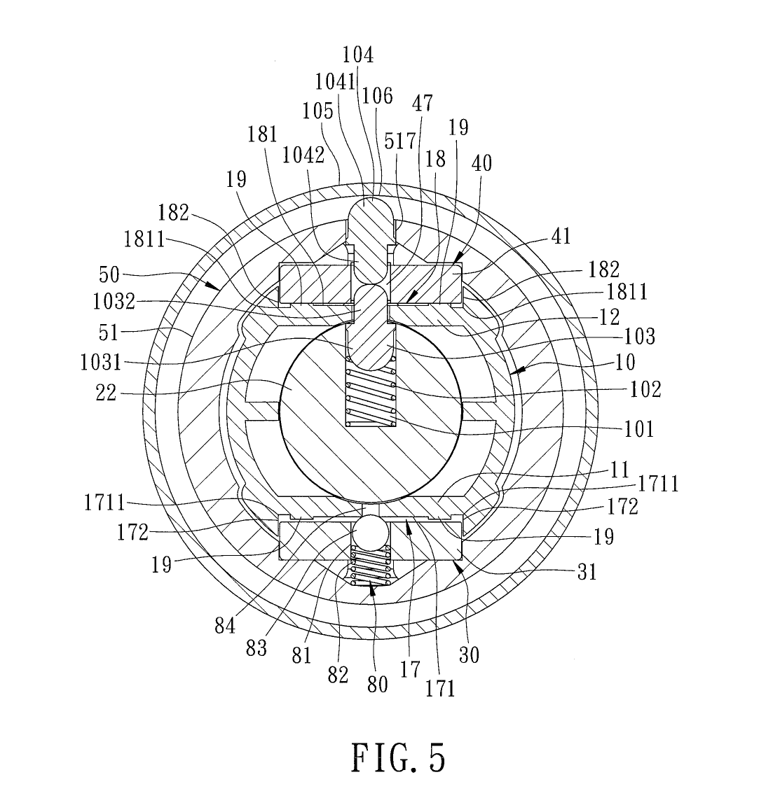

In this embodiment, the first engaging groove 17 has a substantially U-shaped cross section defined cooperatively by a base surface 171 that has opposite transverse ends 1711 (see FIG. 5) extending in the direction of the axis (I), and a pair of side surfaces 172 that extend perpendicularly and respectively from the transverse ends 1711. The second engaging groove 18 has a substantial U-shaped cross section defined cooperatively by a base surface 181 that has opposite transverse ends 1811 (see FIG. 5) extending in the direction of the axis (I), and a pair of side surfaces 182 that extend perpendicularly and respectively from the transverse ends 1811.

Preferably, the main member 10 further has a plurality of protrusion bars 19 provided on the base surfaces 171, 181 of the first and second engaging grooves 17, 18 and extending along the axis (I).

The driven unit 20 includes a driven shaft 21, a coupling seat 22, a flange 24 and a connecting pin 25. The driven shaft 21 is rotatable about the axis (I). The coupling seat 22 has one end coupled to the driven shaft 21 so as to be driven rotatably by rotation of the driven shaft 21, is coupled to the main member 10, and is formed with a connecting hole 23 extending through the coupling seat 22 in the direction perpendicular to the axis (I). The flange 24 is formed at said one end of the coupling seat 22. The connecting pin 25 is inserted through the connecting hole 23 of the coupling seat 22 and the first and second through holes 15, 16 of the first and second side walls 11, 12 of the main member 10. In such configuration, the main member 10 is co-rotatable with the coupling seat 22.

Preferably, the driven unit 20 further includes an annular ring 26 surrounding the coupling seat 22 and abutting against the flange 24.

Each of the first and second movable members 30, 40 has an engaging end portion 31, 41 and a pivot end portion 32, 42.

For each of the first and second movable member 30, 40, the engaging end portion 31, 41 is disposed to engage slidably with a respective one of the first and second engaging grooves 17, 18, is in slidable contact with the protrusion bars 19 in the respective one of the first and second engaging grooves 17, 18, and is formed with a pair of threaded holes 33, 43.

For each of the first and second movable member 30, 40, the pivot end portion 32, 42, which is opposite to the engaging end portion 31, 41 in the direction of the axis (I), extends beyond the first and second side walls 11, 12, and has an inner surface that faces toward the base surface 171, 181 of the respective one of the first and second engaging grooves 17, 18, and that is formed with a protrusion 34, 44 and a first pivot hole 35, 45 extending through the protrusion 34, 44.

By virtue of the abovementioned engagement configuration of the first and second movable members 30, 40 with respect to the first and second engaging grooves 17, 18 of the first and second side walls 11, 12, displacement of the first and second movable members 30, 40 relative to the first and second engaging grooves 17, 18 along the axis (I) is smooth and stable. Moreover, since the side surfaces 172 corresponding to the first engaging groove 17 are abutted against the first movable members 30 and the side surfaces 182 corresponding to the second engaging groove 18 are abutted against the second movable member 40, the main member 10 and the first and second movable members 30, 40 may be driven to rotate about the axis (I) to generate a relatively high rotational torque. Furthermore, by virtue of the protrusion bars 19, areas of the base surfaces 171, 181 with which the first and second movable member 30, 40 are in contact are reduced, thereby reducing friction between the base surface 171 and the first movable member 30 and that between the base surface 181 and the second movable member 40.

In this embodiment, the operating unit 50 includes a sleeve member 51 that is sleeved onto the main member 10 and the engaging end portion 31, 41 of each of the first and second movable members 30, 40, and three securing members 52 that cooperate to secure the sleeve member 51 to the engaging end portion 31, 41 of each of the first and second movable members 30, 40.

The sleeve member 51 is formed with three third through holes 511, two of which are registered respectively with the threaded holes 33 of the first movable member 30, and one of which is registered with one of the threaded holes 43 of the second movable member 40, and a fourth through hole 512 registered with the other one of the threaded holes 43 of the second movable member 40.

In this embodiment, each of the securing members 52 is configured as a bolt extending through a respective one of the third through holes 511 and engaging threadedly a corresponding one of the threaded holes 33, 43 so that the sleeve member 51 is co-movable with the first and second movable members 30, 40 in the direction of the axis (I).

It is worth mentioning that the sleeve member 51 may be directly adhered or welded to the first and second movable members 30, 40 so as to eliminate the need for the threaded holes 33, 43, the third through holes 511, and the securing members 52.

The limiting unit 60 is provided on the main member 10 and the sleeve member 51 of the operating unit 50 for limiting movement of the first and second movable members 30, 40 together with the sleeve member 51 along the first and second engaging grooves 17, 18. The limiting unit 60 has an elongated hole member 61 formed in the second side wall 12 of the main member 10 and extending in the direction of the axis (I), and a hole-engaging member 62 connected to the sleeve member 51, extending through the second movable member 40, and engaging slidably the elongated hole member 61.

The elongated hole member 61 has a first hole end 611 proximate to the second through hole 16 and an second hole end 612 opposite to the first hole end 611 along the axis (I).

In this embodiment, the hole-engaging member 62 is configured as a bolt, and is extended through the fourth through hole 512 of the sleeve member 51 for engaging threadedly the other of the threaded holes 43 of the second movable member 40 and for engaging slidably the elongated hole member 61.

The reversible tool unit 70 includes a base block 71 that is disposed between the pivot end portions 32, 42 of the first and second movable members 30, 40, a pivot pin 74 that extends in the direction transverse to the axis (I) and that connects pivotally the base block 71 to the pivot end portions 32, 42 of the first and second movable members 30, 40, first and second tool heads 72, 73 that are connected respectively to axially-opposite sides of the base block 71 in opposite directions along the axis (I), and first and second chucks 75, 76 that serve to hold respectively the first and second tool heads 72, 73 and that are insertable into the main member 10.

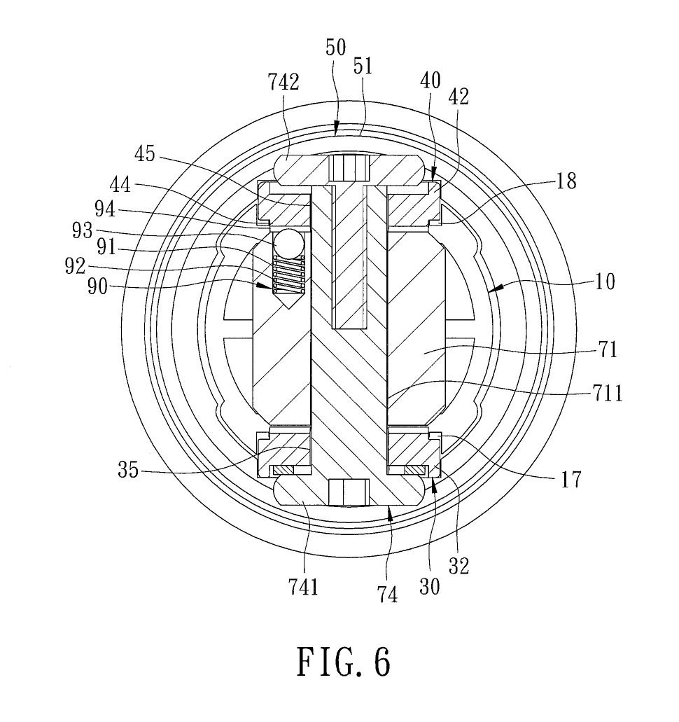

The base block 71 is formed with a second pivot hole 711 registered with the first pivot holes 35, 45. The pivot pin 74 is extended through the first pivot holes 35, 45 and the second pivot hole 711 so that the reversible tool unit 70 is pivoted to the pivot pin 74 and is thus rotatable thereabout (see FIG. 6). In this embodiment, the pivot pin 74 includes a hollow first pivot piece 741 that is extended through the second pivot hole 711 and the first pivot holes 35, 45, and a second pivot piece 742 that is extended into and is fastened to the first pivot piece 741.

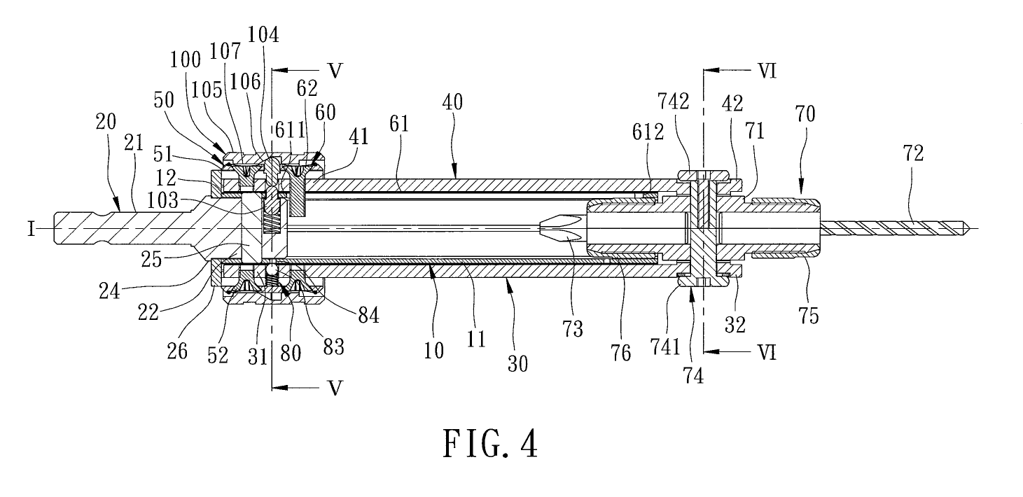

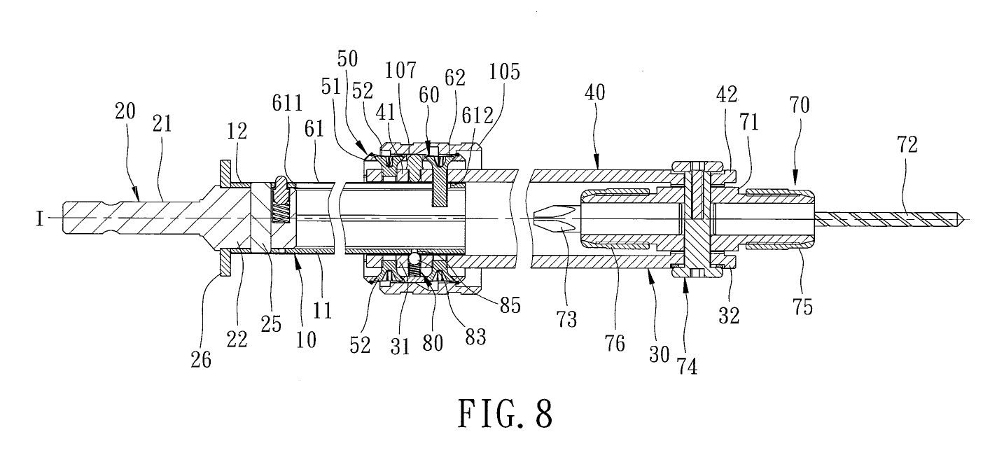

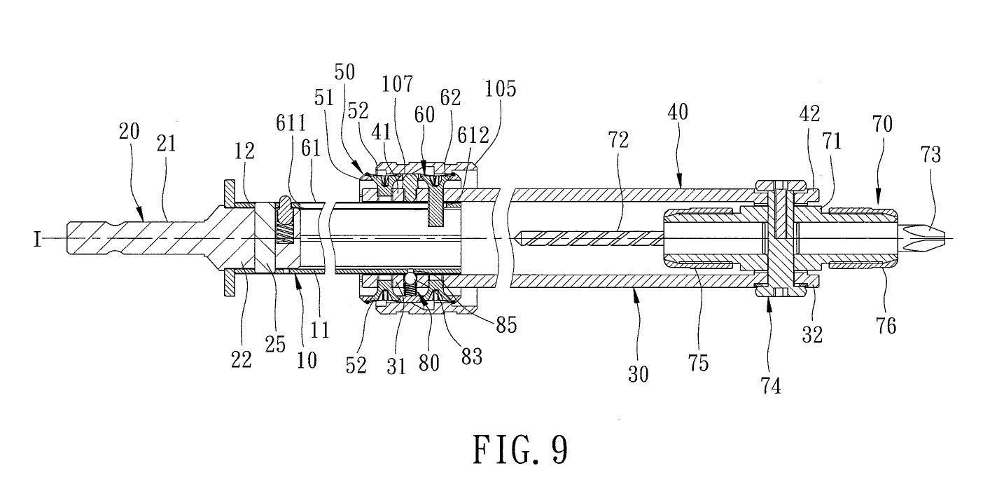

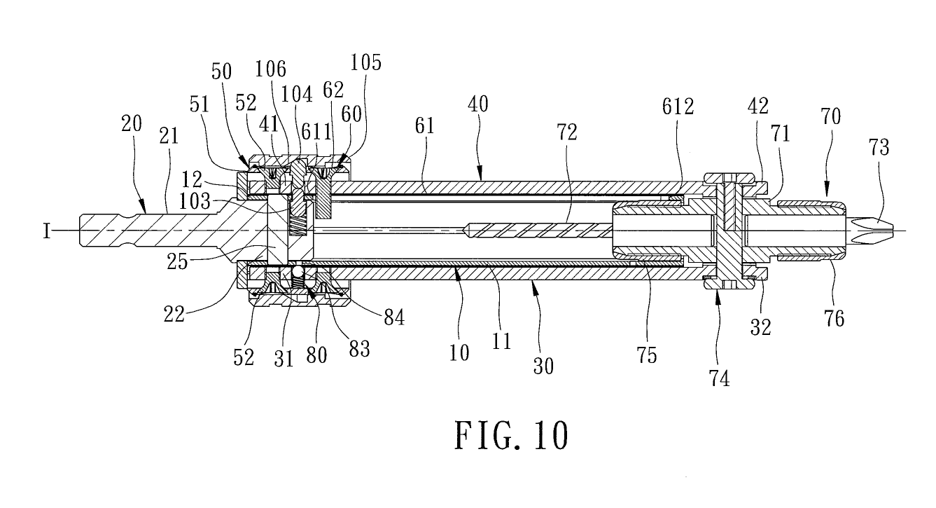

The reversible tool unit 70 is movable along the axis (I) through the movement of the first and second movable members 30, 40 between an extended position (see FIGS. 8 and 9), where the first and second tool heads 72, 73 are separated from the main member 10 and pivot action of the base block 71 together with the first and second tool heads 72, 73 about the pivot pin 74 is permitted, and a retracted position (see FIGS. 4 and 10), where one of the first and second tool heads 72, 73 is retained in the main member 10 and the pivot action of the base block 71 together with the first and second tool heads 72, 73 about the pivot pin 74 is not permitted.

In this embodiment, the first tool head 72 is a drill head and the second tool head 73 is a screwdriver head. Configuration of the first and second tool heads 72, 73 is not limited to such, and may be otherwise according to need.

The positioning unit 80 has a first receiving hole 81 that is formed in the first movable member 30, a first resilient member 82 that is disposed in the first receiving hole 81, first and second positioning holes 84, 85 that are formed in the first side wall 11 of the main member 10, and a first positioning member 83 that is resiliently biased by the first resilient member 82 to engage removably the first and second positioning holes 84, 85 when the reversible tool unit 70 is at the retraced and extended positions, respectively.

In this embodiment, the first resilient member 82 is a compression spring and the first positioning member 83 has the form of a ball.

The angular positioning unit 90 has a second receiving hole 91 formed in the base block 71 of the reversible tool unit 70 and having a blind hole end, a second resilient member 92 that is disposed in the second receiving hole 91, a plurality of angularly spaced-apart positioning grooves 94 that are formed in the protrusion 44 of the second movable member 40, and a second positioning member 93 that is biased by the second resilient member 92 to engage removably one of the positioning grooves 94 when the base block 71 and the first and second tool heads 72, 73 are rotated about the pivot pin 74 to an angular position corresponding to said one of the positioning grooves 94.

In this embodiment, the protrusion 44 of the second movable member 40 is formed with four of the positioning grooves 94, and the second positioning member 93 has the form of a ball.

The locking unit 100 has a first engaging hole member 47 that is formed in the engaging end portion 41 of the second movable member 40, and a second engaging hole member 517 that is formed in the sleeve member 51 of the operating unit 50 and that is registered with the first engaging hole member 47 when the reversible tool unit 70 is at the retracted position. The locking unit 100 further has a receiving hole member 101, an engaging component 103, an elastic member 102, a driving component 104, and a surrounding control member 105.

The receiving hole member 101 is a blind hole that extends in the direction perpendicular to the axis (I) into the coupling seat 22, and that is registered with the first and second engaging hole members 47, 517 when the reversible tool unit 70 is at the retracted position.

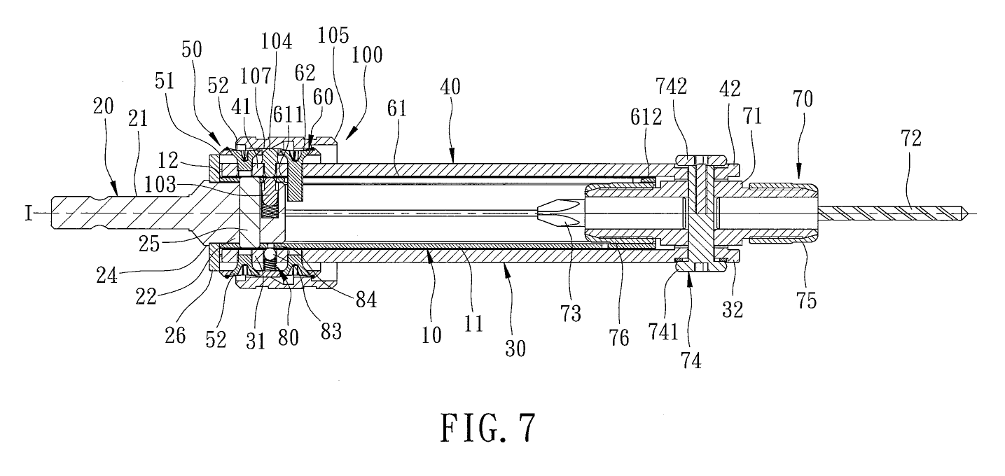

The engaging component 103 has a first end part 1031 disposed movably in the receiving hole member 101, and a second end part 1032 extending removably into the first engaging hole member 47. The elastic member 102 is disposed in the receiving hole member 101, and has opposite ends abutting respectively against the blind hole end of the receiving hole member 101 and the second end part 1032 of the engaging component 103 (see FIG. 5). The driving component 104 has a first end part 1041 extending movably through the second engaging hole member 517, and a second end part 1042 extending movably into the first engaging hole member 47 and being in contact with the second end part 1032 of the engaging component 103. The surrounding control member 105 is disposed to surround the sleeve member 51, and has a locking segment 106 and an unlocking segment 107 having an inner diameter smaller than that of the locking segment 106. The surrounding control member 105 is movable between a locked position (see FIGS. 4, 5 and 10), where the locking segment 106 is brought into contact with the first end part 1041 of the driving component 104 and movement of the second movable member 40 along the second engaging groove 18 is not permitted, and an unlocked position (see FIG. 7), where the unlocking segment 107 is brought into contact with the first end part 1041 of the driving component 104 to push the second end part 1032 of the engaging component 103 against a resilient force of the elastic member 102 and out of the first engaging hole member 47, thereby permitting the movement of the second movable member 40 along the second engaging groove 18.

In use, referring to FIG. 4, the reversible tool unit 70 is initially disposed at the retracted position, while the surrounding control member 105 is disposed at the locked position, the hole-engaging member 62 of the limiting unit 60 is disposed at the first hole end 611 of the elongated hole member 61, the first positioning member 83 of the positioning unit 80 engages the first positioning hole 84, the first tool head 72 is exposed, the second tool head 73 of the reversible tool unit 70 is received in the main member 10, and the second chunk 76 abuts against inner sides of the first and second side walls 11, 12 of the main member 10, such that pivoting of the reversible tool unit 70 about the pivot pin 74 is not permitted. As such, the driven shaft 21 and the first tool head 72 may be rotatably driven by a pneumatic device.

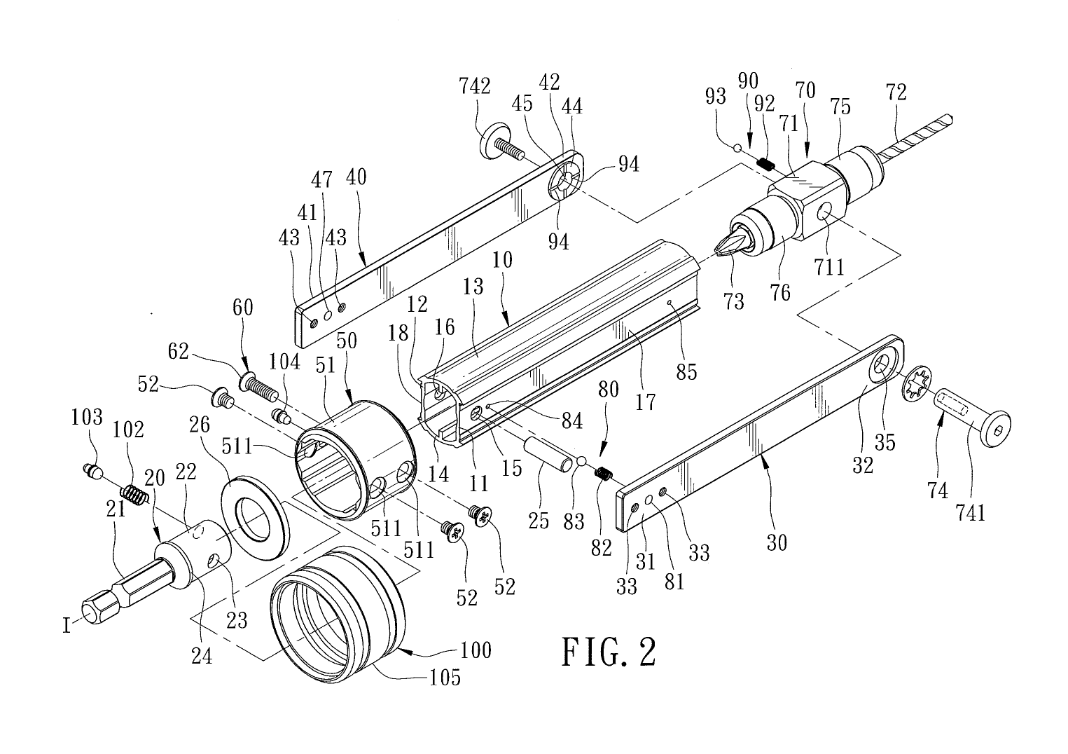

To use the second tool head 73, as shown in FIGS. 4, 7 and 8, the surrounding control member 105 is moved from the locked position into the unlocked position to disengage the second end part 1032 of the engaging component 103 from the first engaging hole member 47 of the second movable member 40. Next, the sleeve member 51 is moved in the direction of the axis (I) together with the first and second movable members 30, 40 and the reversible tool unit 70. During the movement of the sleeve member 51 and the first and second movable members 30, 40, the hole-engaging member 62 is moved along the elongated hole member 61 until the hole-engaging member 62 is stopped by the second hole end 612, while the reversible tool unit 70 is moved from the retracted position to the extended position. At this moment, the first positioning member 83 of the positioning unit 80 is moved away from the first positioning hole 84 to engage the second positioning hole 85. As further shown in FIGS. 2, 6 and 9, during rotation of the reversible tool unit 70, when the base block 71 and the first and second tool heads 72, 73 are rotated about the pivot pin 74 with an angle of one of 90, 180, 270 and 360 degrees, which correspond respectively to the positioning grooves 94, the second positioning member 93 of the angular positioning unit 90 is biased to engage the corresponding one of the positioning grooves 94 for correspondingly positioning the reversible tool unit 70 relative to the main member 10. When the base block 71 and the first and second tool heads 72, 73 are rotated with 180 degrees, the second tool head 73 is exposed to the ambience while the first tool head 72 is received between the first and second movable members 30, 40. Then, as further shown in FIG. 10, the sleeve member 51 is moved in a reverse manner for moving the reversible tool unit 70 back into the retracted position until the hole-engaging member 62 is stopped by the first hole end 611 of the elongated hole member 61. At this moment, the first positioning member 83 of the positioning unit 80 is disengaged from the second positioning hole 84 for reengaging the first positioning hole 84, the first tool head 72 of the reversible tool unit 70 is received in the main member 10, and the first chunk 75 abuts against the inner sides of the first and second side walls 11, 12 of the main member 10, such that pivoting of the reversible tool unit 70 about the pivot pin 74 is not permitted. As such, the driven shaft 21 and the second tool head 73 may be rotatably driven by a pneumatic device. Lastly, the surrounding control member 105 is moved into the locked position for engaging the engaging component 103 with the first engaging hole member 47.

When a relatively large friction is yielded between a workpiece (not shown) and one of the first and second tool heads 72, 73, the one of the first and second tool heads 72, 73 may not easily be disengaged from the workpiece. The engagement between the engaging component 103 and the first engaging hole member 47 ensures that the first and second movable members 30, 40 and the reversible tool unit 70 are co-movable with the operating unit 50 along the axis (I), and can effectively prevent the reversible tool unit 70 from being inadvertently moved into the extended position when a user holds the sleeve member 51 of the operating unit 50 to remove the reversible tool assembly of the invention from the workpiece.

From the foregoing, the reversible tool assembly of this invention has the following advantages:

1. Since the reversible tool unit 70 is mounted between the pivot end portions 32, 42 of the first and second movable members 30, 40, and the base block 71 and the first and second tool heads 72, 73 are pivotable on the pivot pin 74 when the reversible tool unit 70 is manipulated into the extended position, the reversible tool assembly of this invention has a relatively high structural strength, and the pivot pin 74 has a relatively long service life, such that the reversible tool assembly is able to withstand a high rotational torque.

2. By virtue of the limiting unit 60, the positioning unit 80 and the angular positioning unit 90, in comparison with the prior art, positioning of the reversible tool unit 70 relative to the main member 10 is relatively facilitated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A reversible tool assembly comprising:
a main member surrounding an axis, and having first and second sidewalls that are disposed at opposite sides of and that extend parallel to the axis, and a pair of interconnecting walls that interconnect said first and second sidewalls, said first and second sidewalls being formed respectively with first and second engaging grooves that extend in the direction of the axis;
a driven unit including a driven shaft that is rotatable on the axis, and a coupling seat that is driven rotatably by said driven shaft and that is coupled to said main member such that said main member is co-rotatable with said coupling seat;
first and second movable members, each having an engaging end portion that engages slidably a respective one of said first and second engaging grooves, and a pivot end portion that is opposite to said engaging end portion in the direction of the axis;
an operating unit including a sleeve member that surrounds said main member and that is coupled co-movably to said first and second movable members;
a limiting unit provided on said main member and said sleeve member of said operating unit for limiting movement of said first and second movable members together with said sleeve member along the first and second engaging grooves;
a reversible tool unit including a base block that is disposed between said pivot end portions of said first and second movable members, a pivot pin that extends in a direction transverse to the axis and that connects pivotally said base block to said pivot end portions of said first and second movable members, and first and second tool heads that extend respectively from axially-opposite sides of said base block in opposite directions along the axis;
wherein said reversible tool unit is movable through the movement of said first and second movable members between an extended position, where said first and second tool heads are separated from said main member and pivot action of said base block together with said first and second tool heads on said pivot pin is permitted, and a retracted position, where one of said first and second tool heads is retained in said main member and pivot action of said base block together with said first and second tool heads on said pivot pin is not permitted.

2. The reversible tool assembly as claimed in claim 1, wherein said limiting unit has an elongated hole member formed in said second sidewall of said main member and extending in the direction of the axis, and a hole-engaging member connected to said sleeve member, extending through said second movable member, and engaging slidably said elongated hole member.

3. The reversible tool assembly as claimed in claim 2, wherein said hole-engaging member is configured as a bolt extending through said sleeve member and said second movable member into said elongated hole member.

4. The reversible tool assembly as claimed in claim 1, further comprising a positioning unit including:
a first resilient member that is disposed in said first movable member;
first and second positioning holes that are formed in said first sidewall of said main member; and
a first positioning member that is biased by said first resilient member to engage removably said first and second positioning holes when said reversible tool unit is at the retraced and extended positions, respectively.

5. The reversible tool assembly as claimed in claim 4, further comprising an angular positioning unit including:
a second resilient member that is disposed in said base block of said reversible tool unit;
a plurality of angularly spaced-apart positioning grooves that is formed in said second movable member; and
a second positioning member that is biased by said second resilient member to engage removably a respective one of said positioning grooves when said base block and said first and second tool heads are pivoted to a corresponding angular position.

6. The reversible tool assembly as claimed in claim 1, wherein said driven unit further includes a connecting pin that extends transversely through said coupling seat and said first and second sidewalls of said main member.

7. The reversible tool assembly as claimed in claim 1, wherein said each of said first and second engaging grooves is defined cooperatively by a base surface that has opposite elongated ends extending in the direction of the axis, and a pair of side surfaces extending from said elongated ends of said base surface.

8. The reversible tool assembly as claimed in claim 7, wherein said main member further has a plurality of protrusion bars provided on said base surfaces of said first and second engaging grooves and in slidable contact with said first and second movable members.

9. The reversible tool assembly as claimed in claim 7, wherein said sleeve member of said operating unit surrounds said main member and said engaging end portions of said first and second movable members, said operating unit further including at least one securing members that secures said sleeve member to said engaging end portions of said first and second movable members.

10. The reversible tool assembly as claimed in claim 1, further comprising a locking unit having:
a first engaging hole member that is formed in said engaging end portion of said second movable member;
a second engaging hole member that is formed in said sleeve member of said operating unit and that is registered with said first engaging hole member when said reversible tool unit is at the retracted position;
a receiving hole member that extends in the direction transverse to the axis into said coupling seat from an outer surrounding surface thereof, that has a blind hole end, and that is registered with said first and second engaging hole members when said reversible tool unit is at the retracted position;
an engaging component that has a first end part disposed movably in said receiving hole member, and a second end part extending removably into said first engaging hole member;
an elastic member that is disposed in said receiving hole member and that has opposite ends abutting respectively against said blind hole end and said second end part of said engaging component;
a driving component that has a first end part extending movably through said second engaging hole member, and a second end part extending movably into said first engaging hole member and being in contact with said second end part of said engaging component; and
a surrounding control member that surrounds said sleeve member and that has a locking segment and an unlocking segment having an inner diameter smaller than that of said locking segment, said surrounding control member being movable between a locked position, where said locking segment is in contact with said first end part of said driving component and the movement of said second movable member along the second engaging groove is not permitted, and an unlocked position, where said unlocking segment is in contact with said first end part of said driving component to push said second end part of said engaging component out of said first engaging hole member against a resilient force of said elastic member, thereby permitting the movement of said second movable member along the second engaging groove.
